(19) United States
(12) Patent Application Publication
(10) Pub. No.: US 2016/0125707 A1
(43) Pub. Date: May 5, 2016

(54) BACKLIGHT INDICATOR FOR REFLECTIVE DISPLAY SCREENS

(71) Applicant: Kobo Inc., Toronto (CA)

(72) Inventor: Juan Ernesto Salas Imana, Toronto (CA)

(21) Appl. No.: 14/528,635

(22) Filed: Oct. 30, 2014

(51) Int. Cl. G08B 5/36; G02F 1/167

(52) U.S. Cl. CPC G08B 5/36; G02F 1/167

(57) ABSTRACT

A computing device includes a display assembly having a reflective display screen with front viewing surface and a reflective back layer to reflect light entering from the front viewing surface. A housing circumvents the reflective display screen so that the front viewing surface is at least partially exposed. One or more light sources are positioned behind the display assembly such that light emitted by the one or more light sources is at least partially transmitted by the reflective back layer to the front viewing surface. A processor is provided within the housing to selectively activate the one or more light sources based, at least in part, on a state of the computing device.

### TECHNICAL FIELD

Examples described herein relate to a computing device having a light source positioned behind a reflective display screen.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

Some electronic personal display devices are purpose built devices that are designed to perform especially well at displaying readable content. For example, a purpose built purpose build device may include a display that reduces glare, performs well in high lighting conditions, and/or mimics the look of text on actual paper. While such purpose built devices may excel at displaying content for a user to read, they may also perform other functions, such as displaying images, emitting audio, recording audio, and web surfing, among others.

There also exist numerous kinds of consumer devices that can receive services and resources from a network service. Such devices can operate applications or provide other functionality that links a device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for utilizing applications and providing e-book services on a computing device, according to an embodiment.

FIG. 2 illustrates an example of an e-reading device or other electronic personal display device, for use with one or more embodiments described herein.

FIG. 3 illustrates an embodiment of an e-reading device having a backlight status indicator, according to one or more embodiments.

FIG. 4 illustrates a cross-sectional view of an e-reading device having a light source positioned behind a reflective display screen, according to one or more embodiments.

FIG. 5 illustrates an e-reading system for displaying e-book content, according to one or more embodiments.

FIG. 6 illustrates a method of operating a backlight status indicator for an e-reading device, according to one or more embodiments.

### DETAILED DESCRIPTION

Embodiments described herein provide for a computing device having a backlight status indicator. The backlight status indicator may be used to notify a user of the current state (or change in state) of the computing device. More specifically, the backlight status indicator may be provided by one or more lights sources positioned behind a reflective display screen of the computing device. In contrast, conventional status indicator lights are provided on a housing surface. Positioning the one or more light sources behind the reflective display screen allows the light sources to remain hidden and the housing to appear flush. Furthermore, the housing and the display assembly may form a watertight seal around the internal components (e.g., including the backlight status indicator) of the computing device, thus allowing the device to be substantially water resistant and/or water-proof.

According to some embodiments, a computing device includes a display assembly having a reflective display screen with front viewing surface and a reflective back layer to reflect light entering from the front viewing surface. For example, the reflective display screen may be an electrophoretic display. A housing circumvents the reflective display screen so that the front viewing surface is at least partially exposed. One or more light sources are positioned behind the display assembly such that light emitted by the one or more light sources is at least partially transmitted by the reflective back layer to the front viewing surface. A processor is provided within the housing to selectively activate the one or more light sources based, at least in part, on a state of the computing device.

For some embodiments, the reflective back layer may have an optical transmissivity of less than 40%. In other words, less than 40% of light incident on a surface of the reflective back layer is transmitted through to the other side. In a particular embodiment, less than 20% of the light emitted by the one or more light sources reaches the front viewing surface of the reflective display screen. Further, for some embodiments, a screen stiffener may be coupled to the reflective back layer of the reflective display screen. The screen stiffener may include one or more apertures coinciding with a placement of the one or more light sources. Still further, for some embodiments, the display assembly and the housing may form a watertight seal around the one or more light sources.

For some embodiments, the one or more light sources may include a light emitting diode (LED). For example, the one or more light sources may correspond to a plurality of LEDs of different colors. Alternatively, and/or in addition, the one or more light sources may correspond to one or more multicolored LEDs. The light emitted by the one or more light sources may indicate a status of the computing device. For example, each color of light may be associated with a particular notification type. Such notifications may indicate, for example: an amount of charge stored on a battery of the computing device is below a threshold percentage; when the computing device is connected to and/or disconnected from an external power source; and or when a message or notification is received from another device. For some embodiments, the light sources may also be activated when powering on and/or powering off the computing device.

Among other benefits, examples described herein provide a backlight status indicator that can notify a user of a status of the computing device in an unobtrusive manner. For example, because the backlight status indicator is located within the housing, behind the reflective display screen, the status indicator may be hidden from view and protected from external elements (e.g., such as water or moisture). Furthermore, the relatively low optical transmissivity of the reflective display screen allows light emitted by the backlight status indicator to be noticeable but not distracting to the user while operating (e.g., viewing content on) the computing device.

“E-books” are a form of an electronic publication that can be viewed on computing devices with suitable functionality. An e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., e-reading apps) to view e-books. Still further, some devices (sometimes labeled as “e-readers”) can be centric towards content viewing, and e-book viewing in particular. A “shared e-book” is any e-book that is common to two or more e-book libraries (e.g., belonging to two or more different users). More specifically, each of the users may own or possess a “copy” of a shared e-book (e.g., which may be stored locally on their respective devices).

An “e-reading device” can refer to any computing device that can display or otherwise render an e-book. By way of example, an e-reading device can include a mobile computing device on which an e-reading application can be executed to render content that includes e-books (e.g., comic books, magazines etc.). Such mobile computing devices can include, for example, a mufti-functional computing device for cellular telephony/messaging (e.g., feature phone or smart phone), a tablet device, an ultramobile computing device, or a wearable computing device with a form factor of a wearable accessory device (e.g., smart watch or bracelet, glasswear integrated with computing device, etc.). As another example, an e-reading device can include an e-reader device, such as a purpose-built device that is optimized for e-reading experience (e.g., with E-ink displays etc.).

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

System Description

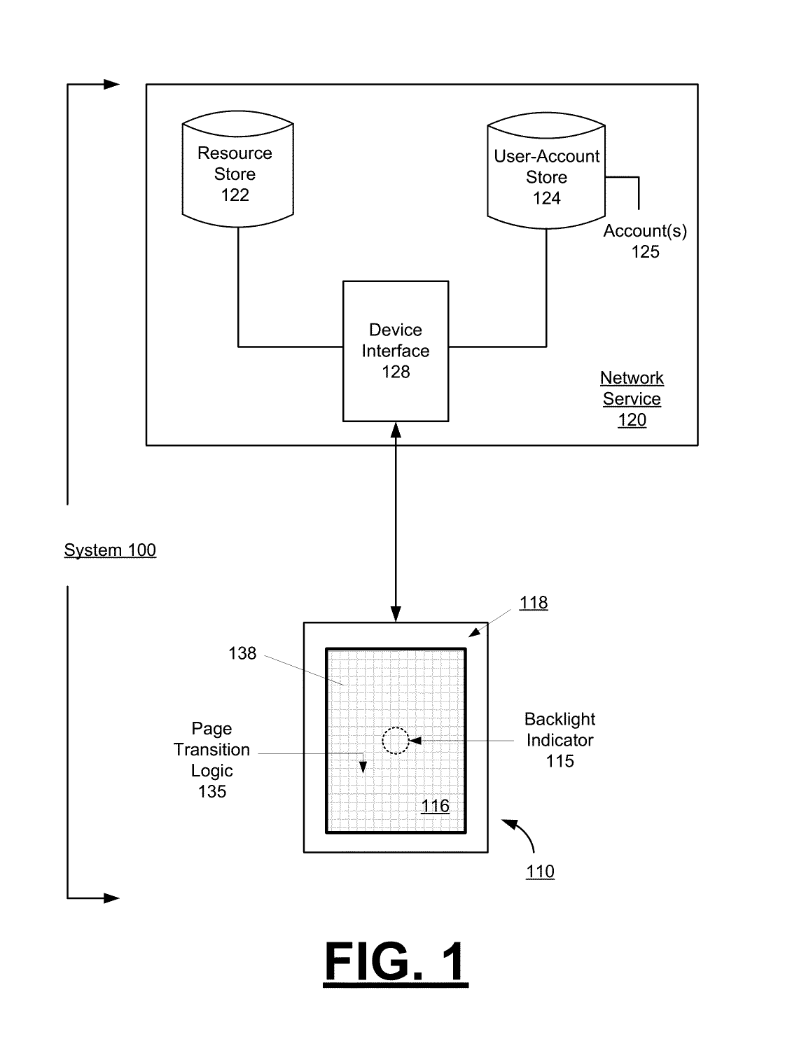

FIG. 1 illustrates a system 100 for utilizing applications and providing e-book services on a computing device, according to an embodiment. In an example of FIG. 1, system 100 includes an electronic display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services which communicate with the e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reading application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122, and a user account store 124. The user account store 124 can associate the e-reading device 110 with a user and with an account 125. The account 125 can also be associated with one or more application resources (e.g., e-books), which can be stored in the resource store 122. As described further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display screen 116 and a housing 118. In an embodiment, the display screen 116 is touch-sensitive, to process touch inputs including gestures (e.g., swipes). For example, the display screen 116 may be integrated with one or more touch sensors 138 to provide a touch sensing region on a surface of the display screen 116. For some embodiments, the one or more touch sensors 138 may include capacitive sensors that can sense or detect a human body's capacitance as input. In the example of FIG. 1, the touch sensing region coincides with a substantial surface area, if not all, of the display screen 116. Additionally, the housing 118 can also be integrated with touch sensors to provide one or more touch sensing regions, for example, on the bezel and/or back surface of the housing 118. The e-reading device 110 may therefore detect and interpret user input made through interaction with the touch sensors 138.

Further, for some embodiments, the e-reading device 110 may include a backlight indictor 115 positioned behind the display screen 116. The backlight indicator 115 may be comprised of one or more individual light sources. More specifically, the backlight indicator 115 may be encased (e.g., sealed) within the housing 118 and the display screen 116. Thus, the backlight indicator 115 may be protected from external elements (e.g., such as water and moisture) while remaining hidden from view when inactive. The backlight indicator 115 may be used to notify the user of the state or status (e.g., battery level, charging status, messages, and/or other notifications) of the e-reading device 110. For example, the backlight indicator 115 may be activated (e.g., turned on or lit) when the amount of charge remaining on the device's battery drops below a threshold percentage. The backlight indicator 115 may also be activated (e.g., in a different color) when the e-reading device 110 is connected to an external power source (e.g., a wall outlet).

In some embodiments, the e-reading device 110 includes features for providing functionality related to displaying paginated content. For example, the page transition logic 115 may enable the user to transition through paginated content (such as e-books). The e-reading device 110 can display pages from e-books, and enable the user to transition from one page state to another. In particular, an e-book can provide content that is rendered sequentially in pages, and the e-book can display page states in the form of single pages, multiple pages, or portions thereof. Accordingly, a given page state can coincide with, for example, a single page, or two or more pages displayed at once. The page transition logic 115 may enable single page transitions, chapter transitions, and/or cluster transitions (e.g., multiple pages at one time).

The page transition logic 115 can be responsive to various kinds of interfaces and actions in order to enable page transitioning. In one implementation, the user can signal a page transition by, for example, interacting with the touch sensing region of the display 116. For example, the user can trigger a page turn (e.g., a forward or backward page transition) input by tapping the surface of the display 116. Alternatively, and/or additionally, the user may trigger a page turn input by swiping the surface of the display 116 (e.g., in the direction of the desired page turn or transition).

Hardware Description

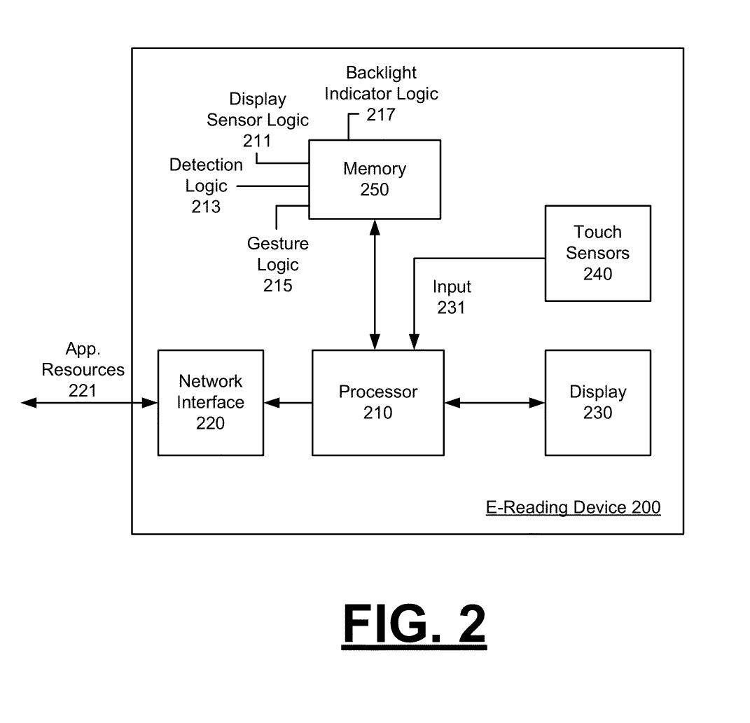

FIG. 2 illustrates an example of an e-reading device 200 or other electronic personal display device, for use with one or more embodiments described herein. In an example of FIG. 2, an e-reading device 200 can correspond to, for example, the device 110 as described above with respect to FIG. 1. With reference to FIG. 2, e-reading device 200 includes a processor 210, a network interface 220, a display 230, one or more touch sensor components 240, and a memory 250.

The processor 210 can implement functionality using instructions stored in the memory 250. Additionally, in some implementations, the processor 210 utilizes the network interface 220 to communicate with the network service 120 (see FIG. 1). More specifically, the e-reading device 200 can access the network service 120 to receive various kinds of resources (e.g., digital content items such as e-books, configuration files, account information), as well as to provide information (e.g., user account information, service requests, etc.). For example, e-reading device 200 can receive application resources 221, such as e-books or media files, that the user elects to purchase or otherwise download from the network service 120. The application resources 221 that are downloaded onto the e-reading device 200 can be stored in the memory 250.

In some implementations, the display 230 can correspond to, for example, a liquid crystal display (LCD), an electrophoretic display (EPD), or a light emitting diode (LED) display that illuminates in order to provide content generated from processor 210. In some implementations, the display 230 can be touch-sensitive. For example, in some embodiments, one or more of the touch sensor components 240 may be integrated with the display 230. In other embodiments, the touch sensor components 240 may be provided (e.g., as a layer) above or below the display 230 such that individual touch sensor components 240 track different regions of the display 230. Further, in some variations, the display 230 can correspond to an electronic paper type display (e.g., based on reflective display technologies), which mimics conventional paper in the manner in which content is displayed and viewed by a user. Examples of such display technologies include electrophoretic displays, electrowetting displays, and electrofluidic displays.

The processor 210 can receive input from various sources, including the touch sensor components 240, the display 230, and/or other input mechanisms (e.g., buttons, keyboard, mouse, microphone, etc.). With reference to examples described herein, the processor 210 can respond to input 231 from the touch sensor components 240. In some embodiments, the processor 210 responds to inputs 231 from the touch sensor components 240 in order to facilitate or enhance e-book activities such as generating e-book content on the display 230, performing page transitions of the e-book content, powering off the device 200 and/or display 230, activating a screen saver, launching an application, and/or otherwise altering a state of the display 230.

In some embodiments, the memory 250 may store display sensor logic 211 that monitors for user interactions detected through the touch sensor components 240 provided with the display 230, and further processes the user interactions as a particular input or type of input. In an alternative embodiment, the display sensor logic 211 may be integrated with the touch sensor components 240. For example, the touch sensor components 240 can be provided as a modular component that includes integrated circuits or other hardware logic, and such resources can provide some or all of the display sensor logic 211 (see also display sensor logic 135 of FIG. 1). For example, integrated circuits of the touch sensor components 240 can monitor for touch input and/or process the touch input as being of a particular kind. In variations, some or all of the display sensor logic 211 may be implemented with the processor 210 (which utilizes instructions stored in the memory 250), or with an alternative processing resource.

In one implementation, the display sensor logic 211 includes detection logic 213 and gesture logic 215. The detection logic 213 implements operations to monitor for the user contacting a surface of the display 230 coinciding with a placement of one or more touch sensor components 240. The gesture logic 215 detects and correlates a particular gesture (e.g., pinching, swiping, tapping, etc.) as a particular type of input or user action. The gesture logic 215 can also detect directionality so as to distinguish between, for example, leftward and rightward swipes.

The memory 250 further stores backlight indicator logic 217 to selectively activate and/or toggle the backlight indicator 115. More specifically, the backlight indicator logic 217 may monitor the status of one or more elements or components of the e-reading device 200, and may be responsive to changes in the state of e-reading device 200. Aside from powering on and/or powering off the backlight indicator 115, the backlight indicator logic 217 may determine a color, intensity, pattern and/or duration of light to be emitted by one or more light sources that comprise the backlight indicator 115.

For some embodiments, the backlight indicator logic 217 may monitor for changes in the battery level (e.g., the amount of charge stored on the battery) of the e-reading device 200. For example, when the battery level drops below a particular threshold, the backlight indicator logic 217 may turn on or “flash” (e.g., quickly turn on and turn off) the backlight indicator 115 to notify the user of the low battery level. For other embodiments, the backlight indicator logic 217 may detect when the e-reading device 200 is connected (e.g., plugged in) to an external power source, such as a wall outlet. For example, when the e-reading device 200 is plugged into a wall outlet, the backlight indicator logic 217 may turn on the backlight indicator 115 to notify the user that the battery is charging. Still further, for some embodiments, the backlight indicator logic 217 may detect when the e-reading device 200 receives messages and/or notifications from another device. For example, the backlight indicator logic 217 may turn on or flash the backlight indicator 115 to indicate the arrival of such messages. In yet another embodiment, the backlight indicator logic 217 may flash the backlight indicator 115 to provide a visual confirmation of user input.

To distinguish between the different notification types, the backlight indicator logic 217 may configure the backlight indicator 115 to emit a different colored light (e.g., by turning on a different colored light source or by changing the color of the light source), activate different patterns of light sources, and/or vary the duration of the light (e.g., flash vs. constant on). For some embodiments, the backlight indicator logic 217 may adjust the intensity of light emitted by the backlight indicator 115 based on an amount of ambient light entering the front of the display 230. For example, the backlight indicator logic 217 may increase the intensity of the backlight indicator 115 in brighter conditions to ensure that notifications are noticeable to the user. In contrast, the backlight indicator logic 217 may reduce the intensity of the backlight indicator 115 in dimmer conditions to prevent the notifications from detracting from the viewing experience of the user.

Backlight Status Indicator

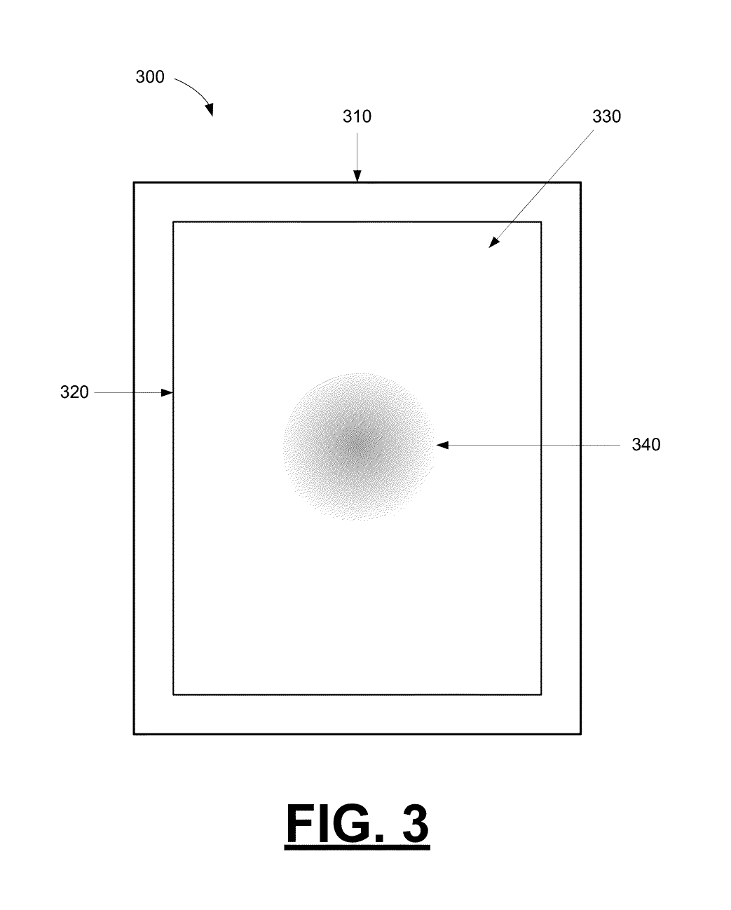

FIG. 3 illustrates an embodiment of an e-reading device having a backlight status indicator, according to one or more embodiments. The e-reading device 300 includes a housing 310 and a reflective display screen 320. The e-reading device 300 can be substantially tabular or rectangular, so as to have a front surface that is substantially occupied by the display screen 320 so as to enhance content viewing. More specifically, the front surface of the housing 310 may be in the shape of a bezel surrounding the display screen 320. The reflective display screen 320 can be part of a display assembly, and can be touch sensitive. For example, the display screen 320 can be provided as a component of a modular display assembly that is touch-sensitive and integrated with housing 310 during a manufacturing and assembly process.

A touch sensing region 330 is provided with at least a portion of the reflective display screen 320. Specifically, the touch sensing region 330 may coincide with the integration of touch sensors with the display screen 320. For some embodiments, the touch sensing region 330 may substantially encompass a surface of the display screen 320. Further, the e-reading device 300 can integrate one or more types of touch-sensitive technologies in order to provide touch sensitivity on the touch sensing region 330 of the reflective display screen 320. It should be appreciated that a variety of well-known touch sensing technologies may be utilized to provide touch-sensitivity, including, for example, resistive touch sensors, capacitive touch sensors (using self and/or mutual capacitance), inductive touch sensors, and/or infrared touch sensors.

For example, the touch-sensing feature of the display screen 320 can be employed using resistive sensors, which can respond to pressure applied to the surface of the display screen 320. In a variation, the touch-sensing feature can be implemented using a grid pattern of electrical elements which can detect capacitance inherent in human skin. Alternatively, the touch-sensing feature can be implemented using a grid pattern of electrical elements which are placed over or just beneath the surface of the display screen 320, and which deform sufficiently on contact to detect touch from an object such as a finger.

For some embodiments, the reflective display screen 320 may be an electrophoretic display (EPD). For example, the reflective display screen 320 may have a reflective back layer to reflect and/or diffuse light entering the front of the display screen 320. The reflective back layer may be formed from a reflective (e.g., “silver”) material such as aluminum. Thus, the optical transmissivity of the reflective display screen 320 may be relatively low (e.g., compared to that of transmissive and/or transflective displays). In a particular example, the reflective back layer may transmit less than 40% of incident light. By reflecting light back towards the front of the display screen 320 (e.g., towards a user of the e-reading device 300), the reflective back layer may enhance the viewability of content displayed on the screen 320.

Further, the e-reading device 300 includes a backlight status indicator 340 positioned behind the reflective display screen 320. The backlight status indicator 340 may be comprised of one or more individual light sources (e.g., LEDs). As described above, the reflective display screen 320 has a relatively low optical transmissivity. Thus, only a portion of the light emitted by the backlight status indicator 340 may reach the front of the display screen 320. For example, the light emitted by the backlight status indicator 340 may be perceived as a subtle glow when viewed from the front of the display screen 320. This allows the backlight status indicator 340 to display notifications to a user of the e-reading device 300, in an unobtrusive manner, while the user is viewing content displayed on the screen 320.

For some embodiments, the e-reading device 300 may adjust the intensity or brightness of the backlight status indicator 340 based on an amount of ambient light (e.g., such as light emitted by a frontlight built into the housing 310) incident on the front viewing surface of the reflective display screen 320. For example, the e-reading device 340 may increase the brightness of the backlight status indicator 340 under brighter ambient lighting, and may decrease the brightness of the backlight status indicator 340 under dimmer ambient lighting. Accordingly, the backlight status indicator 340 may adapt to the brightness of viewing surface to ensure that the light emitted by the backlight status indicator 340 (e.g., for notification purposes) is not distracting to a user while operating the e-reading device 300.

It should be noted that the location and/or configuration of the backlight status indicator 340 as shown in FIG. 3 is for exemplary purposes only. For example, in other embodiments, the backlight status indicator 340 may be positioned in a less conspicuous location (e.g., such as the corners of the display screen 320). Still further, in some embodiments, the backlight status indicator 340 may display various patterns of light to correspond with different types of notifications.

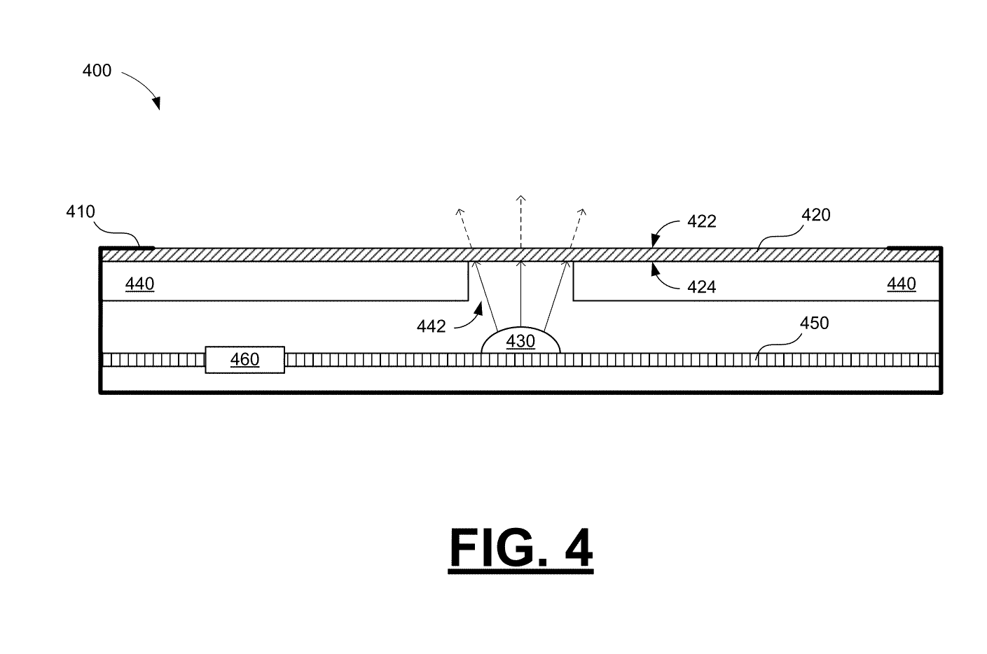

FIG. 4 illustrates a cross-sectional view of an e-reading device 400 having a light source positioned behind a reflective display screen, according to one or more embodiments. The e-reading device 400 includes a housing 410, a reflective display screen 420, and a light source 430. The reflective display screen 420 can be part of a display assembly, and can be touch sensitive. More specifically, the reflective display screen 420 includes a front viewing surface 422 and a reflective back layer 424. For simplicity, the reflective display screen 420 may be substantially similar, if not identical, in function to the reflective displays screen 320 of the e-reading device 300 (e.g., as described above with respect to FIG. 3). For example, the reflective back layer 424 may be formed from a reflective material to reflect light entering the front viewing surface 422 (e.g., to enhance the viewability of content displayed on the screen 420). Furthermore, the light source 430 may correspond with, and provide functionality similar to, the backlight status indicator 340 of the e-reading device 300.

For some embodiments, the light source 430 may comprise a multicolored LED. More specifically, the light source 430 is positioned such that light emitted by the light source 430 is directed at (e.g., incident on) the reflective back layer 424 of the display screen 420. As described above, the reflective backing layer 424 allows only a portion (e.g., some but not all) of the light emitted by the light source 320 to reach the front viewing surface 422. For some embodiments, the reflective material used in the reflective back layer 424 may be chosen such that the reflective display screen 420 transmits enough of the light from the light source 430 to be noticeable to a user (e.g., less than 20%) without being distracting. For other embodiments, the color and/or intensity of light emitted by the light source 430 may be configured so that the light is noticeable, but not distracting, when viewed from the front viewing surface 422.

The light source 430 is disposed on a printed circuit board (PCB) 450 coupled between the display screen 420 and the housing 410. For some embodiments, the display screen 420 and housing 410 may form a watertight seal around the PCB 450 and the components thereon (e.g., including the light source 430). A battery 460 is coupled to the PCB 450 to provide power to the e-reading device 400 and components thereof (e.g., such as the light source 430 and the display screen 420). For some embodiments, the light source 430 may activate (e.g., turn on) when the amount of charge stored on the battery 460 falls below a threshold level or percentage. For other embodiments, the light source may activate when the battery 460 is charging (e.g., when the e-reading device 400 is connected to an external power source) and deactivate when the battery 460 is fully charged. Although not shown for simplicity, the PCB 450 may include additional components (e.g., processors, memory, etc.) providing the functionality of the e-reading device 400. For some embodiments, the e-reading device 400 may further include a screen stiffener 440 to provide additional structural support to the display screen 420. Further, the screen stiffener 440 may include an aperture 442 coinciding with the location of the light source 430 to enable light emitted by the light source 430 to pass through, unobstructed, to the display screen 420.

It should be noted that the layout and configuration of the e-reading device 400 shown in FIG. 4 have been described for exemplary purposes only. For example, in other embodiments, the e-reading device 400 may include a plurality of light sources that are substantially similar in location and/or function to the light source 430 described above. Furthermore, the light source 430 is not limited to any particular type of lighting technology, color, and/or intensity.

E-Reading Functionality

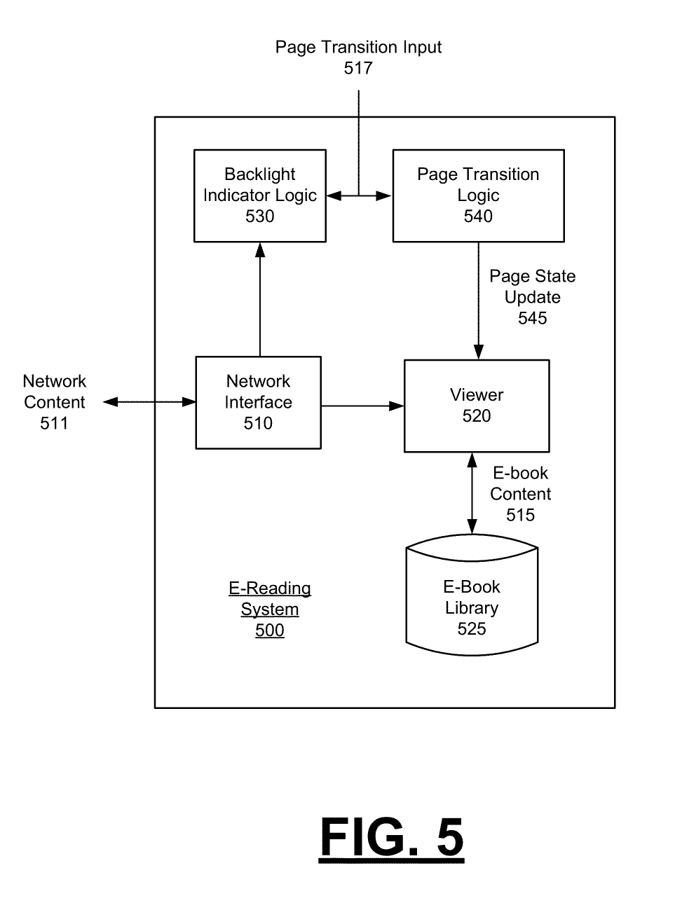

FIG. 5 illustrates an e-reading system 500 for displaying e-book content, according to one or more embodiments. An e-reading system 500 can be implemented as, for example, an application or device, using components that execute on, for example, an e-reading device such as shown with examples of FIGS. 1-4. Furthermore, an e-reading system 500 such as described can be implemented in a context such as shown by FIG. 1, and configured as described by an example of FIGS. 2-4.

In an example of FIG. 5, a system 500 includes a network interface 510, a viewer 520, backlight indicator logic 530, and page transition logic 540. As described with an example of FIG. 1, the network interface 510 can correspond to a programmatic component that communicates with a network service in order to receive data and programmatic resources. For example, the network interface 510 can receive network content 511 from the network service 120. More specifically, the network content 511 may include e-books, which the user purchases and/or downloads, as well as messages from a network server and/or other computing device. E-books can be stored as part of an e-book library 525 with memory resources of an e-reading device (e.g., see memory 250 of e-reading device 200).

The viewer 520 can access e-book content 515 from a selected e-book, provided with the e-book library 525. The e-book content 515 can correspond to one or more pages that comprise the selected e-book. Additionally, the e-book content 515 may correspond to portions of (e.g., selected sentences from) one or more pages of the selected e-book. The viewer 520 renders the e-book content 515 on a display screen at a given instance, based on a display state of the device 500. The display state rendered by the viewer 520 can correspond to a particular page, set of pages, or portions of one or more pages of the selected e-book that are displayed at a given moment.

The page transition logic 540 can be provided as a feature or functionality of the viewer 520. Alternatively, the page transition logic 540 can be provided as a plug-in or as independent functionality from the viewer 520. The page transition logic 540 can signal page state updates 545 to the viewer 520. The page state update 545 can cause the viewer 520 to change or after its current display state. For example, the page transition logic 540 may be responsive to user inputs 517 by signaling page state updates 545 corresponding to page transitions (e.g., single page transition, mufti-page transition, or chapter transition).

For some embodiments, the backlight indicator logic 530 may generate notifications based on user inputs 517 and/or data received via the network interface 510. More specifically, the backlight indicator logic 530 may selectively activate and/or toggle (e.g., power on/off or change the intensity, color, pattern, and/or duration of) a backlight status indicator (e.g., such as described above with respect to FIGS. 1-4) responsive to changes in the state of the e-reading system 500. For some embodiments, the backlight indicator logic 530 may activate or flash the backlight status indicator upon detecting a user input 517 (e.g., to provide visual feedback to the user). Further, for some embodiments, the backlight indicator logic 540 may activate or flash the backlight status indicator in response to network content 511 received via the network interface 510. For example, the backlight status indicator may be used to notify the user when an e-book is successfully downloaded and/or a message is received from the server or another computing device.

Methodology

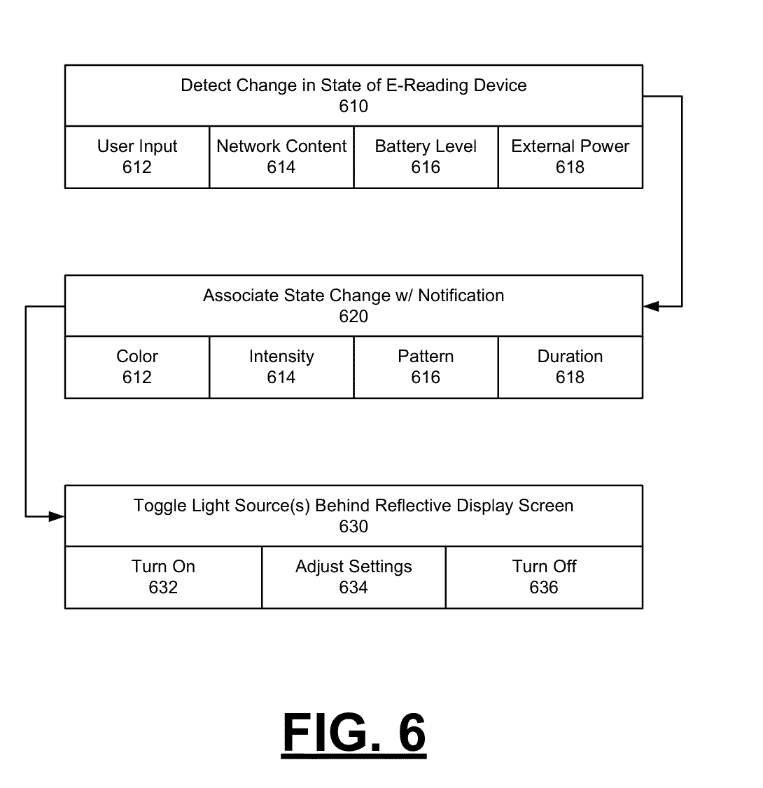

FIG. 6 illustrates a method of operating a backlight status indicator for an e-reading device, according to one or more embodiments. In describing an example of FIG. 6, reference may be made to components such as described with FIGS. 2-4 for purposes of illustrating suitable components for performing a step or sub-step being described.

With reference to an example of FIG. 2, the backlight indicator logic 217 may detect one or more changes in the state of the e-reading device 200 (610). For some embodiments, the changes in state may correspond with inputs and/or data being received by the e-reading device 200. For example, the backlight indicator logic 217 may be responsive to user input received via the touch sensor components 240 (612) and/or network content received via the network interface 220 (614). For other embodiments, the changes in state may correspond with changes to the power being supplied to the e-reading device 200. For example, the backlight indicator logic 217 may be responsive to changes in the battery level of the e-reading device 200 (616) and/or the presence (or absence) of an external power supply (618).

The backlight indicator logic 217 may then associate the state change with a particular notification (620). For some embodiments, the backlight indicator logic 217 may associate different types of state changes with different colors (e.g., wavelengths) of light (612). For example, a “low battery” notification may be associated with a red colored light whereas a “battery charged” notification may be associated with a green colored light. For other embodiments, the backlight indicator logic 217 may associate different types of state changes with different intensities of light (614). For example, more urgent notifications (e.g., low battery alerts) may be associated with brighter light intensities than less urgent notifications (e.g., user input feedback). Further, for some embodiments, the backlight indicator logic 217 may associate different types of state changes with different patterns of light (616). For example, a low battery notification may be associated with a light pattern in the shape and/or likeness of a battery. Still further, for some embodiments, the backlight indicator logic 217 may associate different types of state changes with different durations of light (618). For example, a flashing light may be associated with a low battery notification while a constant-on light may be associated with a battery charging notification.

Finally, the backlight indicator logic 217 may toggle one or more light sources positioned behind a reflective display screen (630). As described above, with respect to FIGS. 3 and 4, the one or more light sources 430 may provide the backlight indicator 340. More specifically, the one or more light sources 430 may be protected from external elements (e.g., such as water and moisture) while remaining hidden from view when inactive. For some embodiments, the backlight indicator logic 217 may power on or activate the light sources to effect a particular notification. For example, the backlight indicator may turn on when the e-reading device 200 receives a message from another device or an amount of charge stored on the battery for the e-reading device 200 falls below a threshold percentage. For other embodiments, the backlight indicator logic 217 may adjust the settings for one or more lights sources to indicate a change in state (634). For example, the light emitted by the backlight indicator may turn from red to green when the battery for the e-reading device 200 becomes fully charged. Still further, for some embodiments, the backlight indicator logic 217 may power off or deactivate the light sources when the user responds to the notification or the notification is no longer relevant (636). For example, the backlight indicator may turn off when a user views a received message and/or the battery for the e-reading device 200 becomes fully charged.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a display assembly including a reflective display screen having a front viewing surface and a reflective back layer to reflect light entering the front viewing surface;
a housing that circumvents the reflective display screen so that the front viewing surface is at least partially exposed;
one or more light sources positioned behind the display assembly, wherein light emitted by the one or more light sources is at least partially transmitted by the reflective back layer to the front viewing surface; and
a processor provided within the housing to selectively activate the one or more light sources based, at least in part, on a state of the computing device.

2. The computing device of claim 1, wherein an optical transmissivity of the reflective back layer is less than 40%.

3. The computing device of claim 1, wherein less than 20% of the light emitted by the one or more light sources reaches the front viewing surface of the reflective display screen.

4. The computing device of claim 1, wherein the reflective display screen is an electrophoretic display.

5. The computing device of claim 1, wherein the one or more light sources includes a light emitting diode (LED).

6. The computing device of claim 5, wherein the one or more light sources comprises a plurality of LEDs of different colors.

7. The computing device of claim 5, wherein the one or more light sources comprises a multicolored LED.

8. The computing device of claim 1, wherein the light emitted by the one or more light sources indicates a status of the computing device.

9. The computing device of claim 1, wherein display assembly further comprises:
a screen stiffener coupled to the reflective back layer, wherein the screen stiffener includes one or more apertures coinciding with a placement of the one or more light sources.

10. The computing device of claim 1, wherein the display assembly and the housing form a watertight seal around the one or more light sources.

11. A method for operating a computing device, the method being implemented by one or more processors and comprising:
detecting a change in state of the computing device, wherein the computing device includes a display assembly having a reflective display screen; and
toggling one or more light sources based on the change in state, wherein the one or more light sources are positioned behind the display assembly so that light emitted by the one or more light sources is at least partially transmitted by a reflective back layer of the reflective display screen to a front viewing surface.

12. The method of claim 11, wherein the reflective display screen is an electrophoretic display.

13. The method of claim 11, wherein toggling the one or more light sources comprises:
activating at least one of the one or more light sources when an amount of charge stored on a battery of the computing device is below a threshold percentage.

14. The method of claim 11, wherein toggling the one or more light sources comprises:
activating at least one of the one or more light sources when the computing device is connected to an external power source.

15. The method of claim 14, wherein toggling the one or more light sources comprises:
deactivating the at least one light source when a battery of the computing device is fully charged.

16. The method of claim 14, wherein toggling the one or more light sources comprises:
changing a color of the at least one light source when a battery of the computing device is fully charged.

17. The method of claim 14, wherein toggling the one or more light sources further comprises:
deactivating the at least one light source when the computing device is disconnected from the external power source.

18. The method of claim 11, wherein toggling the one or more light sources comprises:
activating at least one of the one or more light sources upon receiving a message or notification sent by another device.

19. The method of claim 11, wherein toggling the one or more light sources comprises:
activating at least one of the one or more light sources when powering on or powering off the computing device.

20. A non-transitory computer-readable medium that stores instructions, that when executed by one or more processors, cause the one or more processors to perform operations that include:
detecting a change in state of a computing device, wherein the computing device includes a display assembly having a reflective display screen; and
toggling one or more light sources based on the change in state, wherein the one or more light sources are positioned behind the display assembly so that light emitted by the one or more light sources is at least partially transmitted by a reflective back layer of the reflective display screen to a front viewing surface.
